(19) United States
(12) Patent Application Publication
(10) Pub. No.: US 2019/0112719 A1
(43) Pub. Date: Apr. 18, 2019

(54) DIFUNCTIONAL ELECTRODE AND ELECTROLYSIS DEVICE FOR CHLOR-ALKALI ELECTROLYSIS

(71) Applicant: Covestro Deutschland AG, Leverkusen (DE)

(72) Inventors: Andreas BULAN, Langenfeld (DE); Rainer WEBER, Odenthal (DE); Fabian BIENEN, Leinfelden-Echterdingen (DE)

(21) Appl. No.: 16/090,945

(22) PCT Filed: Apr. 4, 2017
(86) PCT No.: PCT/EP2017/057956

§ 371 Date: Oct. 3, 2018

(30) Foreign Application Priority Data
Apr. 7, 2016 (EP) 16164255.8

(51) Int. Cl. C25B 1/46; C25B 11/04; C25B 9/06; C25B 15/08

(52) U.S. Cl. CPC C25B 1/46; C25B 11/0494; B01J 23/462; C25B 9/066; C25B 15/08; C25B 11/0489

(57) ABSTRACT

The invention relates to an oxygen-consuming electrode for use in chlor-alkali electrolysis which, as required, can either evolve hydrogen or can also consume oxygen, on the basis of a silver-based catalyst and an additional electrocatalyst based on ruthenium and/or iridium. The invention further relates to an electrolysis device consisting thereof. When said electrode is used in the chlor-alkali electrolysis, a correspondingly equipped chlor-alkali electrolysis system can be used for example for network stabilization of power supply networks.

The invention relates to an electrode for chlor-alkali electrolysis which, as required, can either evolve hydrogen or else consume oxygen. When this electrode is used in chlor-alkali electrolysis, the correspondingly equipped chlor-alkali electrolysis plant can be used, for example, for grid stabilization of power grids.

The invention proceeds from oxygen-depolarized electrodes that are known per se for chloralkali electrolysis.

With a bifunctional cathode, chlor-alkali electrolysis (CAEL) can make a contribution to grid stabilization of electrical power grids and energy management. In CAEL, in modern membrane electrolyses, a precious metal oxide-coated hydrogen-evolving cathode is used. The energy consumption according to the prior art is typically about 2300 kWh/t of chlorine (Cl₂). In the case of operation of the CAEL with oxygen-depolarized cathodes (ODC), the energy consumption drops to about 1550 kWh/t of Cl₂. The great difference in energy consumption can be used in energy management for grid stabilization. For instance, in the case of surplus electrical energy in the power grid electrolysis is conducted in hydrogen-producing mode, and in the absence of an energy surplus in oxygen reduction mode.

A disadvantage of other known energy management systems, for example using accumulators or batteries, is that new storage facilities have to be constructed therefor. In the case of bifunctional CAEL, by contrast, it is merely necessary to retrofit existing electrolysis plants. The products such as chlorine and sodium hydroxide solution, which are essential raw materials for the chemical industry (globally about 85 Mt/a, Germany about 5 Mt/a), are still produced—storage of sodium hydroxide solution and chlorine is thus unnecessary. The third product of CAEL is hydrogen which, according to the mode of operation, is generated (standard mode of operation) or not generated (in the case of use of oxygen-depolarized cathodes). In principle, the hydrogen from CAEL is utilized: one portion is used for chemical syntheses, and other is utilized thermally, i.e. combusted in a power plant for power generation. The chemical industry has an immense demand for hydrogen which is sourced essentially from reforming processes. The proportion of hydrogen from CAEL, by contrast, is just 2% of the hydrogen produced/required by the chemical industry (http://www.hydrogeit.de/wasserstoff.htm). Thus, the comparatively small amount of hydrogen in question in the context of grid stabilization by a bifunctional electrolysis process can either be stored without difficulty or replaced by the existing hydrogen production processes.

The problem addressed was that of providing an electrode with which, in the case of an energy surplus, chlor-alkali electrolysis (CAEL) can be operated with high energy consumption, meaning that the electrolysis produces chlorine (Cl₂), sodium hydroxide solution (NaOH) and hydrogen (H₂). In the case of energy scarcity, the CAEL can be operated in oxygen-depolarized mode (ODC mode), with energy consumption about 30% lower. The substances needed for chemical production, chlorine and sodium hydroxide solution, are still available. The hydrogen, as already mentioned, has only a minor role for the chemical industry since it is produced predominantly from reformers. Through the use of bifunctional electrodes, the existing CAEL based on membrane technology can be retrofitted in a simple manner. Thus, for the Federal Republic of Germany, with the production capacity of 5 Mt of chlorine (11.5 million MWh), about 30%, i.e. 3.45 million MWh of control power is available. Measured by the German power consumption of about 550 TWh, this is about 0.6%.

For performance of bifunctional electrolysis, apart from the bifunctional electrode, the provision of a correspondingly modified electrolysis cell is also necessary. This is based on the standard electrolysis cell technology of CAEL.

WO 2015082319 describes the operation of a cell that has an electrode, not described in any detail, where it is possible to purge the gas space behind the hydrogen-evolving electrode. The efficacy of the arrangement is not demonstrated.

WO 2015091422 states that, in an electrolysis cell, two cathodes that work separately are used. One electrode has direct contact with the membrane; the oxygen-depolarized cathode is then spaced apart from the hydrogen-evolving electrode by an electrolyte gap. The gap can be purged with inert gas. A disadvantage of this method is that it is necessary to install two electrodes in an electrolysis cell, which greatly impairs economic viability. Furthermore, electrodes in direct contact with the membrane are disadvantageous since they have to be contact-connected in a costly and inconvenient manner. Furthermore, the maintenance demands for such a system are comparatively high.

The invention provides a bifunctional electrode for operation as cathode in a chlor-alkali electrolysis, in which either hydrogen is generated at the cathode or, when oxygen is being supplied to the cathode, oxygen is consumed at the cathode, having at least one two-dimensional, electrically conductive carrier and a gas diffusion layer and electrocatalyst based on silver and/or silver oxide (silver catalyst) that has been applied to the carrier, characterized in that the additional electrocatalyst that has been provided is a ruthenium catalyst based on ruthenium and/or ruthenium oxide and/or an iridium catalyst based on iridium and/or iridium oxide, preferably ruthenium catalyst, where the carrier has a catalytic coating with additional electrocatalyst and/or the additional electrocatalyst is in a mixture with the silver catalyst.

A bifunctional electrode for CAEL of the aforementioned type is unknown to date. Dimensionally stable electrodes for evolution of hydrogen are known, as described in WO 2014/082843 A1. In this case, water is reduced electrochemically at the cathode to hydrogen and hydroxide ions. This is done using an electrode consisting of nickel, for example, and modified with a coating based on platinum or on other precious metals or precious metal oxides. These electrodes feature a particularly low overvoltage for the evolution of hydrogen.

In the electrolysis, during shutdown in industrial plants, reverse polarization at the electrodes is observed. This can damage the coatings of the known hydrogen-producing electrodes. The electrodes used in industrial electrolyses have to be largely stable to this reverse polarization in order to enable an adequate service life of the electrode. For this purpose, special coatings have been developed. This optimized coating has at least three different layers. The lowermost layer contains platinum and is in direct contact with the nickel carrier. The middle layer contains a mixture of precious metal oxides (at least 60% by weight of rhodium). The outer layer in direct contact with the electrolyte is based on ruthenium oxide. Cathodes having a coating constructed in this way show significantly higher stability against reverse polarization than electrodes wherein the coating consists of only a single catalytically active layer.

Such notable electrodes are unsuitable for use as a gas diffusion electrode and hence unusable as a bifunctional electrode. However, such electrodes establish basic principles for the efficacy of hydrogen-producing electrodes.

Electrodes that consume oxygen, i.e. reacted oxygen with water to give hydroxide ions, are likewise known in principle. For instance, DE102005023615A1 describes an electrode for the reduction of oxygen to hydroxide ions, based on a compressed powder mixture of silver oxide, PTFE and silver.

Electrodes of this kind are of good suitability for use as gas diffusion electrode for oxygen reduction. However, these electrodes do not show good performance in the evolution of hydrogen and hence cannot be economically operated in hydrogen evolution mode.

With the bifunctional electrode of the invention, it is now possible to solve the aforementioned problems addressed by the invention.

The bifunctional electrode of the invention consists, inter alia, of a carrier element, e.g. a nickel weave. The gas diffusion layer comprising the catalyst that reduces the oxygen is applied to this carrier. This can be effected by dry or wet production methods that are known in principle (see, for example, DE102005023615A1).

In a preferred execution of the electrode, the gas diffusion layer consists at least of a mixture of fluoropolymer and silver catalyst and ruthenium catalyst.

Advantageously, the catalytic coating of the carrier with ruthenium catalyst and/or optionally iridium catalyst is in an amount of 0.05% to 2.5% by weight, preferably 0.1% to 1.5% by weight, based on the total content of silver catalyst, ruthenium catalyst and/or optionally iridium catalyst and fluoropolymer.

In a preferred execution of the invention, the novel electrode is formed in that a mixture of fluoropolymer and silver catalyst and optionally ruthenium catalyst in powder form has been applied to the electrically conductive carrier and compressed.

A particularly preferred execution of the novel bifunctional electrode is characterized in that the content of fluoropolymer in the electrode, especially PTFE as fluoropolymer, is 1% to 15% by weight, preferably 2% to 13% by weight, more preferably 3% to 12% by weight, of fluoropolymer and 99-85% by weight, preferably 98-87% by weight, more preferably 97% to 88% by weight, of silver catalyst, based on the sum total of the contents of fluoropolymer and silver catalyst.

The weight ratio of ruthenium catalyst and optionally iridium catalyst to the silver catalyst, in a preferred execution of the novel electrode, is from 0.05:100 to 3:100, especially from 0.06:100 to 0.9:100.

A particularly advantageous bifunctional electrode has been found to be one having a thickness of 0.2 to 3 mm, preferably 0.2 to 2 mm, more preferably 0.2 to 1 mm.

An advantageous novel bifunctional electrode has also been found to be one in which the area loading with ruthenium catalyst, calculated as ruthenium metal, is 1 to 55 g/m².

Oxygen reduction catalysts used are silver-based catalysts such as silver oxide, especially silver(I) oxide, silver metal powder or mixtures thereof. In addition, in the preparation of the silver catalyst, it is possible to add a ruthenium and/or iridium compound, for example in the form of chloride or dispersed oxide. It is thus possible to produce mixed catalysts composed, for example, of silver oxide with ruthenium oxide or silver with ruthenium oxide.

The electrically conductive carrier of the novel bifunctional electrode especially takes the form of a mesh, nonwoven, foam, weave, braid or expanded metal, and more preferably of a weave.

Particularly preferred material for the electrically conductive carrier in the novel bifunctional electrode is carbon fibers, nickel or silver, preference being given to using nickel as material.

In a selected variant of the invention, the bifunctional electrode includes a silver catalyst consisting of silver, silver oxide or a mixture of silver and silver oxide, where the silver oxide is preferably silver(I) oxide. Most preferably, the silver catalyst consists of silver.

In the novel bifunctional electrode, the gas diffusion layer may have been applied to the outer faces of the carrier on one or two sides; the gas diffusion layer has preferably been applied to the carrier on one side.

For the operation of an oxygen-depolarized cathode, preference is given to a specific construction of the electrolysis cell. It is possible here to use electrolysis cells as described in EP 717130 B1, DE 10108452 C2, DE 3420483 A1, DE 10333853 A1, EP 1882758 B1, WO 2007080193 A2 or WO 2003042430, according to the modification. These cells may be used in principle, but have to be modified such that, for example, a suitable purge apparatus for the cathodic gas space for removal of hydrogen prior to further operation in oxygen-depolarized mode and a device for leading off the hydrogen formed are additionally installed.

After installation of a suitable purge device in the cathode space and a lead-off device for the hydrogen formed, it is possible to utilize, for example, the cell construction as described in WO 2003042430 A2 in order to operate the bifunctional electrode according to the invention, but it is also possible to use other cell constructions, after appropriate modification, for operation of the bifunctional electrode.

The invention consequently also provides a novel electrolysis apparatus for bifunctional operation of a chlor-alkali electrolysis having a cathode at which either hydrogen is generated or, in a gas diffusion layer of the cathode, oxygen is consumed, at least comprising an electrolysis cell for chlor-alkali electrolysis having an anode half-cell, a cathode half-cell and a cationic exchange membrane that separates the anode half-cell and the cathode half-cell from one another, an anode disposed in the anode half-cell for evolution of chlorine, a cathode disposed in the cathode half-cell, and an inlet for optional supply of an oxygen-containing gas to a gas space of the cathode half-cell, and inlets and outlets for the reactant streams and product streams, characterized in that the cathode used is the above-described bifunctional electrode of the invention.

In a preferred variant of the aforementioned novel electrolysis apparatus, the latter has at least one inlet for purging the gas space of the cathode half-cell with inert gas. It is thus possible to prevent the mixing of hydrogen from the hydrogen-producing mode with oxygen from the oxygen-depolarized mode which is hazardous to operation.

The electrode of the invention permits operation of the electrolyzer in both aforementioned modes of operation with high efficacy. This means that the electrolyzer can be operated in oxygen reduction mode (oxygen reduction reaction=ORR) and in hydrogen evolution mode (hydrogen evolution reaction=HER). The oxygen reduction mode is to be called ORR mode hereinafter, and the hydrogen evolution mode HER mode. In ORR mode, oxygen and water are converted to hydroxide ions at the cathode. In HER mode, water reacts at the cathode to give hydroxide ions and hydrogen.

In the case that there is a electrolyte gap in the electrolysis cell between ion exchange membrane and the bifunctional electrode, it is advantageous when the hydrogen generated does not get into the gap between ion exchange membrane and bifunctional electrode, since the result of this would be that the gas bubbles would electrically block the surface of the bifunctional electrode or of the ion exchange membrane and this would cause a rise in the cell voltage which can lead to damage to the ion exchange membrane and adversely effect the economic viability of the overall process.

The invention also provides a bifunctional method of chlor-alkali electrolysis, wherein either, in the case of low supply of electrical power from the power grid connected to the electrolysis cell, the cathode is supplied with oxygen-containing gas to the gas space of the cathode half-cell and oxygen is reduced at the cathode at a first cell voltage, or, in the case of high supply of electrical power from the power grid connected to the electrolysis cell, the cathode is not supplied with any oxygen-containing gas and hydrogen is generated at the cathode at a second cell voltage higher than the first cell voltage, characterized in that the electrolysis apparatus used is an above-described electrolysis apparatus according to the invention having the novel bifunctional electrode as cathode.

The bifunctional electrode of the invention can preferably be operated in such a way that, with slightly elevated pressure on the side of the electrode directed toward the liquid, the hydrogen generated is not released into the gap between electrode and membrane but released via the side of the bifunctional electrode facing the gas side. In this way, accumulation of hydrogen gas bubbles in the gap and disruption of the electrolysis process are prevented.

The direction in which the hydrogen is released can be achieved either by virtue of the electrode properties per se or by virtue of the operation with higher pressure on the alkali side in relation to the gas pressure on the gas side.

The term “alkali” is understood here and hereinafter to be mean alkali metal solution, preferably sodium hydroxide or potassium hydroxide solution, more preferably sodium hydroxide solution.

Advantageously, the operation of the bifunctional electrode, in a preferred execution of the novel electrolysis method, is at a pressure differential between the pressure on the alkali side to the gas pressure on the other side of the electrode of greater than 0.1 mbar but less than 100 mbar. In this case, the absolute pressure on the alkali side is in principle dependent on 1. the construction height of the electrode, 2. on the density of the alkali and 3on the gas pressure above the alkali. If the pressure on the alkali side is stated, this relates to the pressure of the alkali at the lowest point of the electrode in the cell, to an alkali having a concentration of 32% by weight or the concentration specified in each case and lastly to the atmospheric gas pressure above the liquid alkali level. Since the pressure on the gas side is independent of the construction height, this is taken to be constant viewed over the construction height.

The invention further provides for the use of the novel electrolysis apparatus for chlor-alkali electrolysis, combined with flexible utilization of electrical power for optional storage of electrical energy in the form of hydrogen. According to the prior art, hydrogen can be produced by renewable means only via water electrolysis by means of renewably generated power. At the same time, the oxygen co-product is formed at the anode, which in many cases finds no economic use and has to be released to the atmosphere. Furthermore, in order to be able to utilize the renewably generated energy, it is necessary to construct separate plant for the water electrolysis, which means a high capital cost. Furthermore, these plants can be operated only with a comparatively low overall load, i.e. only whenever sufficient renewable energy is available. As a result, there is a very high level of wear in these plants, which impairs economically viable utilization, meaning that the hydrogen generated becomes extremely costly. By contrast, the advantage of the novel bifunctional electrolysis is that the hydrogen generation can be conducted in existing plants that have to be altered only slightly and can be operated at full load all year round since the chlorine and sodium hydroxide products are indeed required all year round. Hydrogen management is therefore possible in an infrastructure that in many cases already exists. Considering the state of North Rhine-Westphalia in Germany, for example, there already exists an integrated hydrogen gas system here, which can be used as a storage means for hydrogen, meaning that it is not necessary to make any further investments in infrastructure for hydrogen storage.

Description of the Cell Construction and Test Method:

The electrodes from the examples which follow were characterized in a standard half-cell (FlexCell, from GASKATEL) with a 3-electrode arrangement. The counterelectrode consisted of platinum. The reference electrode used was a reversible hydrogen electrode (RHE, HydroFlex, from GASKATEL). The third electrode was the electrode to be characterized in each case, the test electrode.

Conductive connection of the RHE to the test electrode, for measurement of the potential at the surface of the test electrode, was ensured by means of a Haber-Luggin capillary. The separation of the Haber-Luggin capillary, i.e. of its opening from the electrode surface, is defined via the cell design of the half-cell. The temperature in the cell was adjusted via an electrolyte circuit with heat exchanger.

In oxygen reduction mode (ORR mode), the gas space on the reverse side of the test electrode was purged with an excess of oxygen, establishing a gas pressure of 0.5-5 mbar. This was achieved by passing the gas from the gas space through a water seal.

In hydrogen evolution mode (HER mode), the gas space beyond the test electrode was purged with nitrogen. The gas pressure of the nitrogen here was likewise 0.5-5 mbar. In addition, the gas phase of the electrolyte space, to prevent an explosive hydrogen/oxygen gas reaction, was purged with nitrogen during the HER mode.

In both modes of operation, the projected active area was 3.14 cm² and the concentration of the sodium hydroxide solution was 32% by weight. In ORR mode, the temperature of the sodium hydroxide solution was 80° C. and the current density in the measurement was 4 kA/m². Owing to the disruptive effects of the hydrogen gas bubbles on the potential measurement, the electrode in HER mode was examined at a sodium hydroxide solution temperature of about 63° C. and a current density of 1.5 kA/m².

Characterization was effected in potentiostatic operation at the abovementioned current density by means of electrochemical impedance spectroscopy with a Zahner IM6 potentiostat by the CPE (constant phase element) model. The potential measured is corrected using the current that has flowed in each case and using what is called the R3 resistance measured, which contains the resistances such as those of the electrolyte, that of the test electrode and that of the connecting cable. This corrected potential serves as comparative parameter.

For coating experiments on the nickel weave with ruthenium oxide or iridium oxide, a nickel weave that had a wire thickness of 0.14 mm and a mesh size of 0.5 mm was used. The coating was effected in 5 to 10 coating cycles. This was done using an about 15% by weight solution of RuCl₃ dissolved in n-butanol (76.7% by weight) and hydrochloric acid (8.1% by weight). The ruthenium content in pure RuCl₃ coating solution was 6.1% by weight. Each application was followed by drying at 353 K and a sintering operation at 743 K, each for 10 minutes. After the last coating operation, the weave was finally sintered at 793 K for 60 minutes.

The amounts applied were ascertained on the basis of the increase in weight of the nickel weave by weighing before and after the coating process. The amount applied was based on the geometric weave area.

In order to efficiently operate the novel electrode in an electrolyzer, there should preferably be avoidance, in ORR mode, of penetration of oxygen into the electrolyte or of penetration of electrolyte into the gas space. In HER mode, by contrast, the hydrogen generated must not penetrate into the electrolyte. If gas gets into the electrolyte, active sites on the electrode and regions of the membrane are blocked by gas bubbles. The consequence of this blockage is that these regions become electrochemically inactive and hence there is a rise in the local current density, the consequence of which is an increase in cell voltage, which greatly impairs the economic viability of the method. Blocking of the membrane with gas bubbles can also lead to damage to the membrane and hence to premature exchange of the membranes, which has disadvantages in economic terms.

The electrode of the invention has properties which do not allow penetration of damaging gas volumes into the electrolyte in ORR mode and enable the drainage of the hydrogen into the gas space of the cell in HER mode. This can be effected by simple adjustment of the pressure differential to a small size.

The novel electrode and its operation are to be described in detail by way of example in working examples which follow.

### EXAMPLES

### Example 1—Operation of an Inventive Electrode

For the experiments, a 3-chamber laboratory cell having an ion exchange membrane and electrode area of 100 cm² was used. The first chamber one consisted of the anode chamber that was charged with a sodium hydroxide solution, the charge volume having been chosen such that the effluxing concentration of NaCl was about 210 g/L and the temperature about 85° C. The anode used consisted of an expanded metal that had been provided with a commercial ruthenium oxide-based anode coating for evolution of chlorine from DENORA. The membrane used was a Nafion N982. The second chamber was defined via the distance of the membrane from the bifunctional electrode of 3 mm, and there was a flow of sodium hydroxide solution through the second chamber such that the temperature of the sodium hydroxide solution leaving the chamber was 85° C. and the concentration 31.5% by weight. The third chamber serves for supply and removal of gas. In the case of operation of the bifunctional electrode in ORR mode, O₂ was introduced into the chamber.

In the case of HER mode, the hydrogen escaped on the side of the of the bifunctional electrode that faced the gas space, given a sufficiently selective pressure level and pressure differential, and did not get into the second chamber.

The electrode of the invention was operated at different pressure differentials. The pressure differential reported is the differential that results from the pressure on the side of the electrode directed to the liquid and the pressure on the side of the electrode directed to the gas side. The amount of hydrogen that could be withdrawn from the second chamber was in each case as specified below:

| | | | Amount of H₂ from 2nd chamber |
|---|---|---|---|
| Liquid | Gas | Pressure | as percentage of the total |
| pressure | pressure | differential | amount of H₂ formed |
| [mbar] | [mbar] | [mbar] | [%] |
| 28 | 0 | 28 | 0.8 |
| 28 | 30 | −2 | 7.9 |
| 28 | 59 | −31 | 33.2 |
| 28 | 70 | −42 | 43.9 |
| 46 | 0 | 46 | 0.0 |
| 46 | 30 | 16 | 0.0 |
| 46 | 59 | −13 | 23.1 |
| 46 | 70 | −24 | 30.9 |

At an alkali pressure of 46 mbar and up to a gas pressure of 30 mbar, all the hydrogen is led off via the third chamber. This is not possible at a lower alkali pressure, in spite of the same pressure differential.

### Example 2—Comparative Example—HER Mode—(Prior Art)

As described above under “Description of the cell construction and test method”, an RuO2-coated nickel weave is produced and used. This will be used as reference for HER mode. A nickel weave of size 7 cm×3 cm (wire thickness: 0.15 mm; mesh size: 0.5 mm) was coated with RuO₂. The amount of RuO₂ applied was 8.2 g/m² (where the area in m² is the geometrically projected area found as the area when the product of electrode length and width is calculated, where the area corresponds to that opposite the anode). This cathode was examined by the principle described above in a half-cell; see “Description of the cell construction and test method” section. The potential for HER mode corrected by the R3 resistance was −169 mV vs. RHE (measured at 1.5 kA/m², sodium hydroxide solution temperature: 63° C., NaOH conc.: 32% by weight). This type of electrode fundamentally cannot be operated in ORR mode.

### Example 3—Comparative Example—ORR Mode (Prior Art)

For ORR with an oxygen-depolarized cathode (ODC), an ODC was produced according to the example of DE 10 2005 023 615 A1 and characterized as above. The potential for ORR mode, corrected by the R3 resistance, was +740 mV vs. RHE (4.0 kA/m², sodium hydroxide solution temperature: 80° C., NaOH conc.: 32% by weight).

### Example 4—Comparative Example: ODC According to Prior Art (from Example 3) Operated in HER Mode (Hydrogen Evolution Mode)

Since there has not yet been any description of a bifunctional electrode and it is not possible to operate a hydrogen-evolving electrode in oxygen reduction mode, the ODC known according to the example from the prior art according to DE 10 2005 023 615 A1 was operated in hydrogen evolution mode.

For this purpose, the electrode as operated in HER mode in example 2 was characterized. The potential for HER mode, corrected by the R3 resistance, was −413 mV vs. RHE (1.5 kA/m², sodium hydroxide solution temperature: 63° C., NaOH: 32% by weight).

Hydrogen was evolved at a worse potential by 244 mV by comparison with the hydrogen evolution electrode known from the prior art (example 2).

### Example 5—Inventive Bifunctional Cathode—Use of an RuO2-Coated Ni Weave as Carrier and Current Distributor in the Gas Diffusion Layer

For the bifunctional cathode according to the invention, the carrier of the electrode from example 3 was replaced by an RuO₂-coated Ni weave. The weave was produced as described in example 2. This carrier was used as carrier for the gas diffusion layer analogously to the example of DE 10 2005 023 615 A1 described. This electrode was installed into the half-cell and characterized as described above.

The potential for ORR mode, corrected by the R3 resistance, is +785 mV vs. RHE (4.0 kA/m², sodium hydroxide solution temperature: 80° C., NaOH: 32% by weight).

Thus, the potential for the ORR is 45 mV better than that of the ODC known according to the prior art from DE 10 2005 023 615 A1.

The potential for HER mode, corrected by the R3 resistance, was −277 mV vs. RHE (1.5 kA/m², sodium hydroxide solution temperature: 63° C., NaOH: 32% by weight).

Thus, the electrode is only 108 mV worse than the electrode from the prior art according to example 2 that has been optimized for the evolution of hydrogen (HER mode) and simultaneously better in operation in ORR mode.

### Example 6—Bifunctional Electrode (Inventive): Silver Oxide (Ag₂O)-Based Gas Diffusion Layer with 1% by Weight of Added RuO₂ Powder

For this electrode, an electrode was manufactured analogously to the example of DE 10 2005 023 615 A1. However, the composition of the catalyst mixture was different, as follows: 5% by weight of PTFE, 7% by weight of Ag, 87% by weight of Ag₂O and 1% by weight of RuO₂ (ACROS: 99.5% anhydride). The potential of the bifunctional electrode for HER, at −109 mV vs RHE, was 60 mV better than that of the standard electrode (RuO₂) for the evolution of hydrogen.

The potential of the bifunctional electrode in ORR mode was 794 mV vs. RHE by 54 mV better than the ODC known from the prior art (see example 3) in ORR mode.

### Example 7—Bifunctional Electrode with 3% by Weight of Added RuO₂ Powder (Inventive)

For this electrode, an electrode was manufactured according to DE 10 2005 023 615 A1. However, the composition of the catalyst mixture was as follows: 5% by weight of PTFE, 7% by weight of Ag, 85% by weight of Ag₂O and 3% by weight of RuO₂ (ACROS: 99.5% anhydride).

The potential of the bifunctional electrode for HER, at −146 mV vs RHE, was slightly poorer by 37 mV than that of the electrode with 1% by weight of RuO₂ powder.

The potential of the bifunctional electrode in ORR operation, at 702 mV vs. RHE, was slightly poorer by 92 mV than that of the electrode with 1% by weight of RuO₂.

This electrode in HER operation is also comparatively better than the known hydrogen-evolving electrode (example 2).

The electrodes of the invention thus achieve an unknown synergism in relation to bifunctional use in chloralkali electrolysis under hydrogen production conditions and oxygen-depolarized conditions.

1.-16. (canceled)

17. A bifunctional electrode for operation as cathode in a chlor-alkali electrolysis, in which either hydrogen is generated at the cathode or, when oxygen is being supplied to the cathode, oxygen is consumed at the cathode, having at least one two-dimensional, electrically conductive carrier and a gas diffusion layer and electrocatalyst based on silver and/or silver oxide (silver catalyst) that has been applied to the carrier, wherein the additional electrocatalyst that has been provided is a ruthenium catalyst based on ruthenium and/or ruthenium oxide and/or an iridium catalyst based on iridium and/or iridium oxide, preferably ruthenium catalyst, where the carrier has a catalytic coating with additional electrocatalyst and/or the additional electrocatalyst is in a mixture with the silver catalyst.

18. The electrode as claimed in claim 17, wherein the gas diffusion layer consists at least of a mixture of fluoropolymer and silver catalyst and optionally ruthenium catalyst.

19. The electrode as claimed in claim 17, wherein the catalytic coating of the carrier with ruthenium and/or optionally iridium catalyst is present in an amount of 0.05% to 2.5% by weight, preferably 0.1% to 1.5% by weight, based on the total content of silver catalyst, ruthenium catalyst and fluoropolymer.

20. The electrode as claimed in claim 17, wherein a mixture of fluoropolymer and silver catalyst and optionally ruthenium catalyst has been applied to the carrier in powder form and compacted.

21. The electrode as claimed in claim 17, wherein the content of fluoropolymer in the electrode, especially PTFE as fluoropolymer, is 1% to 15% by weight, preferably 2% to 13% by weight, more preferably 3% to 12% by weight, of fluoropolymer and 99-85% by weight, preferably 98-87% by weight, more preferably 97% to 88% by weight, of silver catalyst, based on the sum total of the contents of fluoropolymer and silver catalyst.

22. The electrode as claimed in claim 17, wherein the electrode has a thickness of 0.2 to 3 mm, preferably 0.2 to 2 mm, more preferably 0.2 to 1 mm.

23. The electrode as claimed in claim 17, wherein the silver catalyst consists of silver, silver oxide or a mixture of silver and silver oxide, where the silver oxide is preferably silver(I) oxide, and the silver catalyst preferably consists of silver.

24. The electrode as claimed in claim 17, wherein the gas diffusion layer has been applied to the outer faces of the carrier on one or two sides, preferably to the carrier on one side.

25. The electrode as claimed in claim 17, wherein the weight ratio of ruthenium catalyst and iridium catalyst to the silver catalyst is from 0.05:100 to 3:100, especially from 0.06:100 to 0.9:100.

26. The electrode as claimed in claim 17, wherein the electrically conductive carrier takes the form of a mesh, nonwoven, foam, weave, braid or expanded metal.

27. The electrode as claimed in claim 17, wherein the electrically conductive carrier consists of carbon fibers, nickel or silver, preferably of nickel.

28. The electrode as claimed in claim 17, wherein the area loading of ruthenium catalyst, calculated as ruthenium metal, is 1 to 55 g/m².

29. An electrolysis apparatus for bifunctional operation of a chlor-alkali electrolysis having a cathode at which either hydrogen is generated or, in a gas diffusion layer of the cathode, oxygen is consumed, at least comprising an electrolysis cell for chlor-alkali electrolysis having an anode half-cell, a cathode half-cell and a cationic exchange membrane that separates the anode half-cell and the cathode half-cell from one another, an anode disposed in the anode half-cell for evolution of chlorine, a cathode disposed in the cathode half-cell, and an inlet for optional supply of an oxygen-containing gas to a gas space of the cathode half-cell, and inlets and outlets for the reactant streams and product streams, wherein the cathode used is an electrode as claimed in claim 17.

30. The apparatus as claimed in claim 29, wherein it has at least one inlet for purging of the gas space of the cathode half-cell with inert gas.

31. A bifunctional method of chlor-alkali membrane electrolysis, wherein either, in the case of low supply of electrical power from the power grid connected to the electrolysis apparatus, the cathode is supplied with oxygen-containing gas to the gas space of the cathode half-cell and oxygen is reduced at the cathode at a first cell voltage, or, in the case of high supply of electrical power from the power grid connected to the electrolysis cell, the cathode is not supplied with any oxygen-containing gas and hydrogen is generated at the cathode at a second cell voltage higher than the first cell voltage, wherein the electrolysis apparatus used is an electrolysis apparatus as claimed in claim 29.

32. The method as claimed in claim 31, wherein, in the operation of the cathode for generation of hydrogen, the pressure differential between the gas space of the cathode half-cell and the pressure on the side of the gas diffusion electrode facing the alkali is adjusted such that the hydrogen formed at the cathode is led away exclusively into the gas space of the cathode half-cell.
